(19) United States
(12) Patent Application Publication
(10) Pub. No.: US 2006/0155599 A1
(43) Pub. Date: Jul. 13, 2006

(54) Marketing method for movie theaters

(76) Inventor: Jeffrey L. Chow, Upper Marlboro, MD (US)

Correspondence Address: Donald A. Kettlestrings, Suite 211, 414 Hungerford Drive, Rockville, MD, 20850, US

(21) Appl. No.: 11/098,635

(22) Filed: Apr. 5, 2005

Related U.S. Application Data
(60) Provisional application No. 60/642,407, filed on Jan. 10, 2005.

(51) Int. Cl. G06Q 30/00

(52) U.S. Cl. 705/14

(57) ABSTRACT

A method for marketing movies allows a consumer to purchase a current box office movie on an optically formatted disc at a movie theater and then to view the movie on the disc away from the movie theater. The method also allows a parent to prescreen a current box office film by viewing the optically formatted disc away from the theater and before watching the movie at the theater with the parent's child. A discounted ticket is provided by the theater to the consumer to view the film version of the movie at the movie theater upon return of the disc by the consumer to the theater or upon presentation by the consumer to the theater of a receipt which was provided to the consumer by the theater upon the consumer's purchase of the disc.

### CROSS-REFERENCE TO RELATED APPLICATIONS

This application claims the benefit of U.S. Provisional Application No. 60/642,407, filed Jan. 10, 2005.

### BACKGROUND OF THE INVENTION

This invention relates to a marketing method and more particularly to a marketing method for movie theaters.

Consumers who want to see a movie currently being shown at a movie theater but who are unable to see the movie at the theater for various reasons, such as a tight schedule, etc. now must wait until the movie is available on DVD discs, typically sometime after the movie has finished playing in local theaters. Likewise, parents are now unable to prescreen movies currently playing at movie theaters before permitting their children to see a movie in the theater.

The only products now available which enable consumers to view a movie that is currently being shown in theaters are unauthorized, illegal, bootleg copies of the movie. These bootleg copies do not offer picture clarity anywhere near that of a Blu-ray® or HD-DVD disc, nor do they provide a discount to consumers, should they decide to re-watch the movie at the theater.

Sometimes when purchasing a shrink-wrapped DVD booklet with a supposed bootlegged box office movie inside, consumers walk away with an empty box or a blank/nonfunctional DVD.

The business model of this invention offers protection to consumers and a means to recoup lost revenue for the movie industry.

It is, therefore, an object of the present invention to provide a marketing method for movie theaters which enables consumers to purchase optically formatted discs containing a first-run movie at a movie theater wherein a film version of the movie is currently playing.

Another object is to provide such a method wherein a consumer can view the film version of the movie in the movie theater after purchasing the optically formatted disc by presenting a receipt for the disc to the movie theater, and the consumer would then receive a discount on a ticket for viewing the movie in the theater.

A further object of the invention is the provision of such a method wherein consumers would receive a larger discount for a ticket to view the movie in the theater when they return to see the movie with their children and after presenting the theater with a receipt for their earlier purchase of the disc containing the movie.

Another object of the invention is the provision of such a method wherein consumers are provided with a free ticket by the theater to view the movie in the theater upon the consumer's return of the disc and the receipt for the disc to the theater.

To achieve these and other objects the invention provides a method for marketing movies comprising the steps of: providing a film version of a movie to a movie theater; providing a plurality of optically formatted discs containing the movie to the movie theater; the movie theater selling at least one of the discs to a consumer; the movie theater providing a receipt to the consumer upon the consumer's purchase of the disc; the consumer presenting the receipt to the theater; and the movie theater selling to the consumer a ticket to view the film version of the movie at the movie theater at a first price discounted from a regular price of the ticket upon presentation by the consumer to the movie theater of the receipt.

It is to be understood that both the foregoing general description and the following detailed description are exemplary and explanatory but are not restrictive of the invention.

### DESCRIPTION OF THE PREFERRED EMBODIMENTS

This invention provides a method which allows consumers to watch current box office movies away from the theater on their own time and allows parents to prescreen films before watching them at the theater with their children.

Preferably, uniquely sized, high-capacity Blu-ray® or HD-DVD discs are utlized that restrict the disc's playability in other devices where the media may be duplicated for profit by bootleggers.

The movie industry would release a film version of a new movie to theaters to be played in their projector room as well as an allotment of Blu-ray® or HD-DVD discs (either format as the player for the discs will be able to read both) for sale at the ticket counter. Because these discs are smaller in size and higher in capacity when compared to conventional DVDs, the movie industry would be able to choose if they wanted to include the same trailers/previews as shown in the theater or insert various forms of non-skipable advertisement prior to the movie as a form of potential revenue.

Consumers wanting to see a specific movie currently at theaters, but unable to spend the time at the theater because of a tight schedule or other reason, would be able to stop by a theater offering “Movie-to-go” discs and purchase a disc for the movie and return to their busy schedule. Consumers would then be able to watch the movie on their own time, even pausing or fast-forwarding through parts of their choosing. If consumers decided to watch the movie at the theater after purchasing a disc, they would present their receipt for that movie disc and receive a small discount on the ticket for that movie only. The theater would mark the receipt in a predetermined manner upon its presentation to the theater by the consumer to prevent another use of the receipt to receive a discount.

Parents wanting to prescreen a movie would essentially do the same as general consumers, but would receive a larger discount when they return to see the movie with their children after presenting the cashier with their receipt.

If consumers return the disc with their receipt to the theater, they would be provided one free pass to that movie. This method of recycling gives incentive for consumers to return their disc to the movie house, although not necessary, and less incentive for them to pass the disc off to a friend. The movie house would also benefit from this; by offering consumers a free pass to that movie, consumers would most likely spend money for snacks and drinks to complete their theater experience. Instead of the theater retaining the receipt, the theater could mark the receipt in a predetermined manner, as previously described.

Because these discs are of a unique size and require a specific playeer to view, the threat of copyright infringement or duplication are low as the only means to duplicate these discs would be the quality-reducing “analog loop” of running the image through a TV and out to a VCR/DVD recorder of some sort. Because the outputs for the player have yet to be firmly defined, the risk of duplication could be further lowered by using component outputs or HDMI outputs as opposed to traditional S-video or composite outputs.

The invention in its broader aspects is not limited to the specific details shown and described, and departures may be made from such details without departing from the principles of the invention and without sacrificing its chief advantages.

What is claimed is:

1. A method for marketing movies, comprising the steps of:
providing a film version of a movie to a movie theater;
providing a plurality of optically formatted discs containing said movie to said movie theater;
said movie theater selling at least one of said discs to a consumer;
said movie theater providing a receipt to said consumer upon said consumer's purchase of said disc;
said consumer presenting said receipt to said theater; and
said movie theater selling to said consumer a ticket to view said film version of said movie at said movie theater at a first price discounted from a regular price of said ticket upon presentation by said consumer to said movie theater of said receipt.

2. A method as in claim 1 wherein said movie theater sells to said consumer a ticket to view said movie at said movie theater at a second price discounted from said regular price of said ticket that is less than said first discounted price if said consumer is accompanied by at least one child when purchasing said ticket.

3. A method as in claim 2 further including the step of said movie theater marking said receipt in a predetermined manner when said receipt is presented to said movie theater by said consumer.

4. A method as in claim 3 wherein said discs utilize a blue laser to read data from said discs.

5. A method for marketing movies, comprising the steps of:
providing a film version of a movie to a movie theater;
providing a plurality of optically formatted discs containing said movie to said movie theater;
said movie theater selling at least one of said discs to a consumer;
said consumer returning said at least one disc to said movie theater; and
said movie theater providing to said consumer a ticket to view said film version of said movie at said movie theater at a third price discounted from a regular price of said ticket upon return of said at least one disc to said movie theater by said consumer.

6. A method as in claim 5 wherein said third price is free.

7. A method as in claim 6 wherein said discs utilize a blue laser to read data from said discs.

8. A method for marketing movies, comprising the steps of:
providing a film version of a movie to a movie theater;
providing a plurality of optically formatted discs containing said movie to said movie theater;
said movie theater selling at least one of said discs to a consumer;
said movie theater providing a receipt to said consumer upon said consumer's purchase of said disc;
said consumer returning said at least one disc and said receipt to said movie theater; and
said movie theater providing to said consumer a ticket to view said film version of said movie at said movie theater at a third price discounted from a regular price of said ticket upon return of said at least one disc and said receipt to said movie theater by said consumer.

9. A method as in claim 8 wherein said third price is free.

10. A method as in claim 9 wherein said discs utilize a blue laser to read data from said discs.

11. A method as in claim 8 wherein said receipt is marked by said theater in a predetermined manner and is then returned to said consumer.
